(19) United States
(12) Patent Application Publication
(10) Pub. No.: US 2025/0210236 A1
(43) Pub. Date: Jun. 26, 2025

(54) HIGH-DENSITY LOW-LOSS RARE-EARTH PERMANENT MAGNETIC POWDER, HIGH-DENSITY LOW-LOSS RARE-EARTH BONDED MAGNET, AND PREPARATION METHODS THEREFOR

(71) Applicant: MATERIALS TECHNOLOGY CO., LTD., Yinchuan, Ningxia (CN)

(72) Inventors: Benpei CHENG, Yinchuan, Ningxia (CN); Haiying CHEN, Yinchuan, Ningxia (CN); Siyu LIAO, Yinchuan, Ningxia (CN); Xinan WANG, Yinchuan, Ningxia (CN)

(21) Appl. No.: 18/851,603

(22) PCT Filed: Apr. 15, 2022
(86) PCT No.: PCT/CN2022/087134

§ 371 Date: Sep. 26, 2024

(30) Foreign Application Priority Data
Apr. 14, 2022 (CN) 202210386759.2
Apr. 14, 2022 (CN) 202210392476.9

(51) Int. Cl. H01F 1/059; B22F 9/04; H01F 41/02

(52) U.S. Cl. CPC H01F 1/059; B22F 9/04; H01F 41/0266; B22F 2301/355

(57) ABSTRACT

The present disclosure provides a high-density low-loss rare-earth permanent magnetic powder, a bonded magnet, and preparing methods thereof. A molecular formula of the high-density rare-earth permanent magnetic powder is SmₓFe_{100-x-y-z}M_{y}I_{z}, wherein 6.0≤x≤9.5, 0≤y≤13, and 1≤z≤15.2; and M is a 3d transition-group metal and/or 4d transition-group metal, and I is an interstitial atom, and includes N, or a combination of N and H. The high-density rare-earth permanent magnetic powder has a maximum energy product not less than 36.299 MGOe, and a compression density not less than 5.5 g/cm³. The rare-earth permanent magnetic powder according to the embodiments of the present disclosure, as compared with conventional rare-earth permanent magnetic powders, can have better comprehensive properties. While the magnetic properties have been improved, the density of the magnetic powder can be increased, and the particle-size distribution of the magnetic powder can be more uniform.

The present application claims the priorities of the Chinese patent application filed on Apr. 14, 2022 before the CNIPA, China National Intellectual Property Administration with the application number of 202210392476.9 and the title of “HIGH-DENSITY RARE-EARTH PERMANENT MAGNETIC POWDER AND PREPARING METHOD THEREOF” and the Chinese patent application filed on Apr. 14, 2022 before the CNIPA, China National Intellectual Property Administration with the application number of 202210386759.2 and the title of “HIGH-DENSITY LOW-LOSS RARE-EARTH PERMANENT MAGNETIC MATERIALS AND PREPARING METHOD THEREOF”, which are incorporated herein in their entirety by reference.

### TECHNICAL FIELD

The present disclosure relates to magnetic materials, and particularly to a high-density low-loss rare-earth permanent magnetic powder, a method for preparing the high-density low-loss rare-earth permanent magnetic powder, a high-density low-loss rare-earth bonded magnet, and a method for preparing the high-density low-loss rare-earth bonded magnet.

### BACKGROUND

From 1970s and 80s, rare-earth permanent magnetic materials have been deemed in industry as critical materials in high-technology application fields that are relevant to the conversions of magnetic energy, electric energy and mechanical energy, and the magnetic energy density of the rare-earth permanent magnetic materials has made a significant leap, being several times greater than that of the previous magnetic materials that do not contain the rare-earth components. The rare-earth permanent magnetic materials is usually the general term of the intermetallic compound family formed by rare-earth-transition-group metals with other metals or non-metals, and the combinations between the different components can form permanent magnetic materials of various phase structures that have potential application values.

By far, the commercial rare-earth permanent magnetic materials are mainly neodymium-iron-boron materials prepared by sintering and bonding processes. With the development trends of the downstream electric-machine products of miniaturization, light weighting, high frequency and high rotation speed, the neodymium-iron-boron materials, because of the factors such as that the magnetic properties have already reached the theoretical limits, a large eddy-current loss and complicated formation processes, have been gradually incapable of meeting the demands on updating and development of the downstream industries. Moreover, because the preparation of the neodymium-iron-boron material usually requires the addition of heavy rare-earth elements, it has a high cost, and, due to the market factors, the cost fluctuates largely, to result in weak cost-effectiveness advantage.

Generally, the rare-earth permanent magnetic materials may be mainly applied in the field of high-end electric motors such as high-frequency high-rotation-speed motors and the fields such as high-performance miniature and heterotypic electric motors and sensors, and cover the strategic new industries such as new-energy vehicles, energy-saving environment-friendly variable-frequency appliance, and intelligent manufacturing. For example, in the field of cars, the rare-earth permanent magnetic materials have already been tested in car components such as the car windshield wiper, the electronic accelerator, the blower, the battery, the cooling fan, the sunroof, the power steering, the electrical air conditioner, the opening and closing of the fuel tank cap, the electric window, the car door, the seat regulation, the pre-collision and the electric braking system.

With the rapid development of the permanent magnet driving motors of new-energy vehicles, the peak rotation speed is increasingly higher. Therefore, an electric motor that can have a higher energy efficiency, a smaller size and a lower cost in such a high-rotation-speed environment is needed. That requires that the rare-earth bonded magnets can have better comprehensive properties. However, the conventional rare-earth bonded magnets usually have a good effect in merely the magnetic properties, and have no outstanding advantages in other properties, which causes that the conventional rare-earth bonded magnets cannot be applied well in the existing commercial application environments.

### SUMMARY

The technical problem that the present disclosure seeks to solve is to provide a high-density low-loss rare-earth permanent magnetic powder, a method for preparing the high-density low-loss rare-earth permanent magnetic powder, a high-density low-loss rare-earth bonded magnet, and a method for preparing the high-density low-loss rare-earth bonded magnet, which enables the comprehensive properties of rare-earth bonded magnets to be improved, to enable them to be applied well in current commercial application environments.

In order to solve the above problem, the present disclosure discloses a high-density rare-earth permanent magnetic powder, wherein a molecular formula of the high-density rare-earth permanent magnetic powder is SmₓFe_{100-x-y-z}M_{y}I_{z}, wherein 6.0≤x≤9.5, 0≤y≤13, and 1≤z≤15.2; and M is a 3d transition-group metal and/or 4d transition-group metal, and I is an interstitial atom, and includes N, or a combination of N and H; and the high-density rare-earth permanent magnetic powder has a maximum energy product not less than 36.299 MGOe, and a compression density not less than 5.5 g/cm³.

Optionally, the 3d transition-group metal and/or 4d transition-group metal includes one or more of Ti, V, Cr, Mn, Co, Ni, Cu, Zn, Zr, Nb and Mo.

Optionally, a particle size of the high-density rare-earth permanent magnetic powder is 0.6 μm≤x10≤0.92 μm, 2 μm≤x50≤2.55 μm, and 5.93 μm≤x99≤8.1 μm.

Optionally, the high-density rare-earth permanent magnetic powder has a remanence not less than 14.289 kGs, and an intrinsic coercive force not less than 10.255 kOe.

Optionally, the high-density rare-earth permanent magnetic powder has a weight-increase percentage less than 3.2% in a thermogravimetric analysis at 400° C. in an air atmosphere.

The present disclosure further discloses a method for preparing the high-density rare-earth permanent magnetic powder, wherein the method includes:
acquiring a raw material, wherein the raw material includes an Sm element, an Fe element, and the 3d transition-group metal and/or 4d transition-group metal, and a ratio of the Sm element, the Fe element and the 3d transition-group metal and/or 4d transition-group metal in the raw material is equal to a ratio of the elements in the high-density rare-earth permanent magnetic powder;
preparing a samarium-iron master alloy by using the raw material;
performing a gas-solid-phase reaction of the samarium-iron master alloy in nitrogen or a mixed gas of nitrogen and hydrogen, to form a samarium-iron-nitrogen alloy SmₓFe_{100-x-y-z}M_{y}I_{z}; and
grinding the samarium-iron-nitrogen alloy, to obtain the high-density rare-earth permanent magnetic powder.

Optionally, the step of preparing the samarium-iron master alloy by using the raw material includes:
by using the raw material, based on a strip-casting technique, preparing the samarium-iron master alloy.

Optionally, in the step of, by using the raw material, based on the strip-casting technique, preparing the samarium-iron master alloy, a rotation speed of a roller is 50-80 m/s, and a thickness of the prepared samarium-iron master alloy is less than 1 mm.

Optionally, in the gas-solid-phase reaction, a reaction temperature is 400-800° C., a duration is 1-200 hours, and a gas pressure is 0.1-2.0 MPa.

Optionally, in a process of the grinding, a total energy output is 60-80 KJ.

The present disclosure further provides a high-density low-loss rare-earth bonded magnet, wherein the high-density low-loss rare-earth bonded magnet includes the high-density rare-earth permanent magnetic powder, a binder and a processing aid.

Optionally, the binder includes at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene, and/or includes at least one of a copolymer, a blend and a polymer alloy that are formed based on at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene.

Optionally, the binder includes a thermoplastic elastomer.

Optionally, the processing aid includes at least one of a coupling agent, a plasticizer, a lubricant and a flame retardant.

Optionally, the coupling agent includes a titanate-type coupling agent and/or a silane-type coupling agent.

Optionally, the plasticizer includes at least one of dioctyl phthalate DOP, a stearate salt, a fatty acid, a phosphate ester, a benzenopoly acid ester and an alkyl sulfonic acid ester.

Optionally, the lubricant includes at least one of silicone oil, wax, a fatty acid, oleic acid, polyester, a synthesized ester, a carboxylic acid, aluminium oxide, silicon dioxide and titanium dioxide.

The present disclosure further provides a method for preparing the high-density low-loss rare-earth bonded magnet, wherein the method includes:
mixing the high-density rare-earth permanent magnetic powder, the binder and the processing aid, to obtain a mixture; and
treating the mixture by extrusion molding or injection molding in an environment where a magnetic orientation field is greater than 8 kOe, to generate the high-density low-loss rare-earth bonded magnet.

Optionally, the step of treating the mixture by extrusion molding or injection molding in the environment where the magnetic orientation field is greater than 8 kOe, to generate the high-density low-loss rare-earth bonded magnet includes:
if the extrusion molding is employed, milling the mixture in a mixing mill, to heat and melt the mixture, subsequently loading the mixture into a single-screw extruder where a magnetic orientation field is greater than 8 kOe, extruding by using the single-screw extruder, and subsequently cooling for formation, to obtain the high-density low-loss rare-earth bonded magnet.

Optionally, the step of treating the mixture by extrusion molding or injection molding in the environment where the magnetic orientation field is greater than 8 kOe, to generate the high-density low-loss rare-earth bonded magnet includes:
if the injection molding is employed, treating the mixture by using a double-screw extruder into a hybrided pellet; and
heating to melt the hybrided pellet, subsequently adding the hybrided pellet into an injection molding machine where a magnetic orientation field is greater than 8 kOe, and injection-molding, to obtain the high-density low-loss rare-earth bonded magnet.

As compared with the prior art, the present disclosure has the following advantages:

The rare-earth permanent magnetic powder according to the embodiments of the present disclosure, as compared with conventional rare-earth permanent magnetic powders, can have better comprehensive properties. While the magnetic properties have been improved, the density of the magnetic powder can be increased, and the particle-size distribution of the magnetic powder can be more uniform. By applying the rare-earth permanent magnetic powder to a rare-earth permanent magnetic material, the comprehensive properties of the rare-earth permanent magnetic material can be effectively improved, to enable the rare-earth permanent magnetic material to be better applied in current commercial application environments.

In the high-density low-loss rare-earth bonded magnet according to the embodiments of the present disclosure, the high-density low-loss rare-earth bonded magnet is prepared by using the high-density rare-earth permanent magnetic powder. Besides the improvement in the magnetic properties of the high-density rare-earth permanent magnetic powder, the density of the magnetic powder can be increased, and the particle-size distribution of the magnetic powder can be more uniform. By applying the rare-earth permanent magnetic powder to the rare-earth bonded magnet, the comprehensive properties of the rare-earth bonded magnet can be effectively improved, and the requirement on the magnetic orientation field in the preparation of the rare-earth bonded magnet is reduced, which can reduce the cost of the preparation of the rare-earth bonded magnet to a certain extent, to enable the rare-earth bonded magnet to be better applied in current commercial application environments.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### DETAILED DESCRIPTION

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

The present disclosure discloses a high-density rare-earth permanent magnetic powder, wherein the molecular formula of the high-density rare-earth permanent magnetic powder is SmₓFe_{100-x-y-z}M_{y}I_{z}, wherein 6.0≤x≤9.5, 0≤y≤13, and 1≤z≤15.2; and M is a 3d transition-group metal and/or 4d transition-group metal, and I is an interstitial atom, and includes N, or a combination of N and H. The high-density rare-earth permanent magnetic powder has a maximum energy product not less than 36.299 MGOe, and a compression density not less than 5.5 g/cm³.

Particularly, in the high-density rare-earth permanent magnetic powder prepared according to the present disclosure, while avoiding using heavy rare-earth metals, by reasonably controlling the composition of the high-density rare-earth permanent magnetic powder, by using a specific synthesizing mode, the finally generated high-density rare-earth permanent magnetic powder has a maximum energy product not less than 36.299 MGOe, and a compression density not less than 5.5 g/cm³. That, while maintaining the good magnetic properties, effectively increases the compression density, whereby the high-density rare-earth permanent magnetic powder can have good comprehensive properties.

Optionally, the 3d transition-group metal and/or 4d transition-group metal includes one or more of Ti, V, Cr, Mn, Co, Ni, Cu, Zn, Zr, Nb and Mo.

Optionally, the particle size of the high-density rare-earth permanent magnetic powder is 0.6 μm≤x10≤0.92 μm, 2 μm≤x50≤2.55 μm, and 5.93 μm≤x99≤8.1 μm.

Particularly, the present disclosure, by using the specific synthesizing mode, while ensuring the wide granularity distribution, increases the compression density, which can reduce the loss after the formation of the magnetic powder, to enable the subsequently prepared rare-earth permanent magnetic material to have better comprehensive properties.

Optionally, the high-density rare-earth permanent magnetic powder has a remanence not less than 14.289 kGs, and an intrinsic coercive force not less than 10.255 kOe.

Particularly, the high-density rare-earth permanent magnetic powder according to the present disclosure has a high magnetic energy product, and therefore can have higher convertible energy. At the same time, it can have high remanence and intrinsic coercive force. With the high remanence and intrinsic coercive force, the magnet can have a better anti-demagnetization capacity and a higher magnetic orientation field, so that the high-density rare-earth permanent magnetic powder can be applied extensively in fields such as consumer electronics, new-energy vehicles, wind power generators and industrial electric motors.

Optionally, the high-density rare-earth permanent magnetic powder has a weight-increase percentage less than 3.2% in a thermogravimetric analysis at 400° C. in an air atmosphere.

Particularly, in the thermogravimetric analysis of the high-density rare-earth permanent magnetic powder, the low weight-increase percentage indicates that the high-density rare-earth permanent magnetic powder can have a good thermal stability, and can maintain its original properties in the high-temperature environment to the largest extent, whereby the high-density rare-earth permanent magnetic powder can be adapted for various different application environments.

The present disclosure further discloses a method for preparing the high-density rare-earth permanent magnetic powder, wherein the method includes:
acquiring a raw material, wherein the raw material includes an Sm element, an Fe element, and the 3d transition-group metal and/or 4d transition-group metal, and a ratio of the Sm element, the Fe element and the 3d transition-group metal and/or 4d transition-group metal in the raw material is equal to a ratio of the elements in the high-density rare-earth permanent magnetic powder;
preparing a samarium-iron master alloy by using the raw material;
performing a gas-solid-phase reaction of the samarium-iron master alloy in nitrogen or a mixed gas of nitrogen and hydrogen, to form a samarium-iron-nitrogen alloy SmₓFe_{100-x-y-z}M_{y}I_{z}; and
grinding the samarium-iron-nitrogen alloy, to obtain the high-density rare-earth permanent magnetic powder.

Particularly, the grinding on the samarium-iron-nitrogen alloy may be performed by using a jet mill and/or a ball mill. The jet mill can use the convergence of a plurality of high-pressure gas flows to cause the coarse particles to repeatedly collide and grind to be pulverized, and the required powder granularity is obtained by controlling the grinding pressure and the rotation speed of the sorting machine.

Optionally, the step of preparing the samarium-iron master alloy by using the raw material includes:
by using the raw material, based on a strip-casting technique, preparing the samarium-iron master alloy.

Particularly, the samarium-iron master alloy is prepared by using the strip-casting technique. As compared with traditional melting techniques such as arc melting and ingot casting, the speed of the cooling of the melt is increased, so that the distribution of the crystalline phase is more uniform. The average particle size of grain distribution of the strips prepared by using that method does not exceed 8 μm, which facilitates the diffusion of the nitrogen atoms and the controlling over the granularity distribution in the subsequent steps.

Optionally, in the step of, by using the raw material, based on the strip-casting technique, preparing the samarium-iron master alloy, the rotation speed of a roller is 50-80 m/s, and the thickness of the prepared samarium-iron master alloy is less than 1 mm. By reasonably controlling the rotation speed of the roller, precipitation of the crystalline phase can be inhibited well in the preparation, to prevent generation of crystal clusters. The width of the columnar crystal of the principal phase may be reduced with the decreasing of the flake thickness. When the flake thickness is low, a large amount of polycrystalline particle or ultrafine powder is formed more easily after the powdering of the flake, whereby a high-density permanent magnetic powder having better comprehensive properties can be obtained.

Optionally, in the gas-solid-phase reaction, the reaction temperature is 400-800° C., the duration is 1-200 hours, and the gas pressure is 0.1-2.0 MPa. By reasonably controlling the reaction conditions of the gas-solid-phase reaction, a good crystalline phase is formed more easily, so that, in the subsequent treatment, the high-density permanent magnetic powder of a good particle-size distribution can be obtained more easily.

Optionally, in the process of the grinding, the total energy output is 60-80 KJ. By reasonably controlling the energy output in the grinding, the prepared high-density permanent magnetic powder can have a better particle-size distribution and a higher intrinsic coercive force.

The process of the reversal magnetization of the monocrystalline samarium-iron-nitrogen magnetic powder has the characteristics of the nucleation mechanism, wherein the remanence and the coercive force of the magnetic powder vary with the particle size of the magnetic powder. The conventional processes tend to focus on the magnetic properties and neglect the practical demands and the effects in the application process. By controlling the powdering parameters and the energy range, the high-density permanent magnetic powder that has good magnetic properties and is suitable for the preparation of the downstream magnet is obtained. It does not solely emphasize the magnitude of a single item of the magnetic properties, and, based on the saturated magnetization and the magnetocrystalline anisotropy field obtained in the preceding steps, realizes the improvement in the comprehensive properties of the magnetic powder. Furthermore, while ensuring the wide granularity distribution, the present disclosure increases the compression density and the coercive force, and reduces the loss after the formation of the magnetic powder. In the prepared high-density permanent magnetic powder, the maximum energy product can reach over 40 MGOe, the remanence can reach over 14.7 kGs, the intrinsic coercive force can reach over 11 kOe, and the TG weight increase (@400° C., and air atmosphere) is ≤3.2%.

As an alternative embodiment of the present disclosure, after the preparation of the high-density permanent magnetic powder has been completed, in order to further improve the oxidation resistance of the magnetic powder and the effect of orientation of the magnetic powder during formation, to lay the basis for the preparation of the high-density low-loss magnet, surface treatment may be performed to the magnet.

Particularly, the process may include dissolving a surface treating agent and the high-density permanent magnetic powder into a mixed solvent containing an alcohol and a ketone, so that the surface treating agent can coat the surface of the high-density permanent magnetic powder.

The surface treating agent may be a coupling agent such as titanate and silane, and so on. It can prevent the magnetic powder from being oxidized in the subsequent process steps, and improve the dispersion and the cohesiveness, to facilitate to subsequently generate better the permanent magnetic material of good properties.

The present disclosure provides a high-density low-loss rare-earth bonded magnet, wherein the high-density low-loss rare-earth bonded magnet includes the high-density rare-earth permanent magnetic powder, a binder and a processing aid.

Particularly, the high-density rare-earth permanent magnetic powder according to the present disclosure, while ensuring the wide granularity distribution, increases the compression density, which can reduce the loss after the formation of the magnetic powder, to enable the subsequently prepared rare-earth bonded magnet to have better comprehensive properties.

Moreover, the high-density rare-earth permanent magnetic powder has a high magnetic energy product, whereby it can not only store a high energy well, but also can have high remanence and intrinsic coercive force. With the high remanence and intrinsic coercive force, the magnet can have a better anti-demagnetization capacity and a higher magnetic orientation field, so that the high-density rare-earth permanent magnetic powder can be applied extensively in fields such as consumer electronics, new-energy vehicles, wind power generators and industrial electric motors.

In the thermogravimetric analysis of the high-density rare-earth permanent magnetic powder, the low weight-increase percentage indicates that the high-density rare-earth permanent magnetic powder can have a good thermal stability, and can maintain its original properties in the high-temperature environment to the largest extent, whereby the high-density rare-earth permanent magnetic powder can be adapted for various different application environments.

As an alternative embodiment of the present disclosure, after the preparation of the high-density permanent magnetic powder has been completed, in order to further improve the oxidation resistance of the magnetic powder and the effect of rotation of the magnetic powder during the magnetic-field formation, to lay the basis for the preparation of the high-density low-loss magnet, surface treatment may be performed to the magnet.

Particularly, the process may include dissolving a surface treating agent and the high-density permanent magnetic powder into a mixed solvent containing an alcohol and a ketone, so that the surface treating agent can coat the surface of the high-density permanent magnetic powder.

The surface treating agent may be a coupling agent such as titanate and silane, and so on. It can prevent the magnetic powder from being oxidized in the subsequent process steps, and improve the dispersion and the cohesiveness, to facilitate to subsequently generate better the bonded magnet of good properties.

Optionally, the binder includes at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene, and/or includes at least one of a copolymer, a blend and a polymer alloy that are formed based on at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene.

The polyamide resin may include, for example, Nylon 6, Nylon 46, Nylon 66, Nylon 610, Nylon 612, Nylon 11, Nylon 12, Nylon 6-12 and Nylon 6-66. The liquid-crystal polymer may be an aromatic polyester and so on. The polyolefin may be polyethylene, polypropylene and so on.

Optionally, the binder includes a thermoplastic elastomer, for example, at least one of styrenes (SBS, SIS, SEBS and SEPS), olefins (TPO and TPV), diolefins (TPB and TPI), chloroethylenes (TPVC and TCPE), urethanes (TPU), esters (TPEE), amides (TPAE), organic fluorines (TPF), organosilicones and ethylenes.

Particularly, the effect of the binder is to increase the fluidity of the magnetic powder particles and the binding strength therebetween, to give the magnet high mechanical performance and corrosion resistance. The type of the binder may be decided according to the formation process or the application demand, and a material having a large binding force, a high bonding strength, a low hydroscopicity and a good dimensional stability is selected as the binder.

For example, if the high-density low-loss rare-earth bonded magnet required to be prepared is a bonded magnet, at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene, and/or at least one of a copolymer, a blend and a polymer alloy that are formed based on at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene may be selected to serve as the binder.

Moreover, if the high-density low-loss rare-earth bonded magnet required to be prepared is a magnetic elastomer, a thermoplastic elastomer may be selected to serve as the binder, and at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene, and/or at least one of a copolymer, a blend and a polymer alloy that are formed based on at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene may also be selected to serve as the binder according to practical demands.

Optionally, the processing aid includes at least one of a coupling agent, a plasticizer, a lubricant and a flame retardant, so that the comprehensive properties of the high-density low-loss rare-earth bonded magnet can be further improved.

Optionally, the coupling agent includes a titanate-type coupling agent and/or a silane-type coupling agent. The coupling agent can effectively enhance the binding between the magnetic powder and the binder, and can facilitate to increase the orientation factor of the powder particles in the magnetic field.

Optionally, the plasticizer includes at least one of dioctyl phthalate DOP, a stearate salt, a fatty acid, a phosphate ester, a benzenopoly acid ester and an alkyl sulfonic acid ester.

Optionally, the lubricant includes at least one of silicone oil, wax, a fatty acid, oleic acid, polyester, a synthesized ester, a carboxylic acid, aluminium oxide, silicon dioxide and titanium dioxide. The plasticizer and the lubricant can improve the properties of the high-density low-loss rare-earth bonded magnet, and can simplify the processing conditions and increase the processing efficiency to a certain extent.

Optionally, the flame retardant includes organic flame retardants and inorganic flame retardants, and halogen flame retardants (organic chlorides and organic bromides) and non-halogen flame retardants. The organic flame retardants include but are not limited to the flame retardants with bromine type, phosphorus-nitrogen type, nitrogen type and red phosphorus and the compounds thereof as the main component. The inorganic flame retardants include but are not limited to the flame retardants with diantimony trioxide, magnesium hydroxide, aluminium hydroxide and silicon type as the main component.

The present disclosure further provides a method for preparing the high-density low-loss rare-earth bonded magnet, wherein the method includes:
mixing the high-density rare-earth permanent magnetic powder, the binder and the processing aid, to obtain a mixture; and
treating the mixture by extrusion molding or injection molding in an environment where a magnetic orientation field is greater than 8 kOe, to generate the high-density low-loss rare-earth bonded magnet.

Particularly, because the high-density rare-earth permanent magnetic powder has a good particle-size distribution, in the preparation of the high-density low-loss rare-earth bonded magnet, the magnetic orientation field can be less than 13 kOe, which is conventionally required, which can reduce the cost of the preparation of the rare-earth bonded magnet to a certain extent, to enable the rare-earth bonded magnet to be better applied in current commercial application environments. Moreover, the rare-earth bonded magnet can have good comprehensive properties.

Optionally, the step of treating the mixture by extrusion molding or injection molding in the environment where the magnetic orientation field is greater than 8 kOe, to generate the high-density low-loss rare-earth bonded magnet includes:
if the extrusion molding is employed, milling the mixture in a mixing mill, to heat and melt the mixture, subsequently loading the mixture into a single-screw extruder where a magnetic orientation field is greater than 8 kOe, extruding by using the single-screw extruder, and subsequently cooling for formation, to obtain the high-density low-loss rare-earth bonded magnet.

In a particular implementation, if the extrusion molding is employed, the addition proportion of the binder and the processing aid may be 4%-30%.

Optionally, the step of treating the mixture by extrusion molding or injection molding in the environment where the magnetic orientation field is greater than 8 kOe, to generate the high-density low-loss rare-earth bonded magnet includes:
if the injection molding is employed, treating the mixture by using a double-screw extruder into a hybrided pellet; and
heating to melt the hybrided pellet, subsequently adding the hybrided pellet into an injection molding machine where a magnetic orientation field is greater than 8 kOe, and injection-molding, to obtain the high-density low-loss rare-earth bonded magnet.

In a particular implementation, if the injection molding is employed, the addition proportion of the binder and the processing aid may be 5%-30%. In the process of treating the mixture by using a double-screw extruder into a hybrided pellet, the temperature may be controlled at 130° C.-350° C. In the process of adding into an injection molding machine where the magnetic orientation field is greater than 8 kOe, and injection-molding, the temperature may be controlled between 190° C. and 350° C.

The magnet may be prepared into various three-dimensional shapes such as a tile shape, cylinder, an annular shape, square and a flat-plate type by using different molds according to practical demands, which is not limited in the present disclosure.

In order to enable a person skilled in the art to comprehend the present disclosure better, the method for preparing the high-density low-loss rare-earth bonded magnet according to the present disclosure will be described below with reference to multiple particular embodiments.

The preparation of the high-density rare-earth permanent magnetic powder

### Example 1

The other raw-material components than nitrogen are mixed, which include the rare-earth element Sm, and Fe, Co and Nb, wherein the atom percentages of the mixture are Sm 8.5%, Fe 76%, Co 8% and Nb 5%.

By using the above raw materials, based on the strip-casting technique, the samarium-iron master alloy is prepared. The rotation speed of the roller is 50 meters per second, the duration of cooling to normal temperature is 10 hours, and a flake with the thickness of 0.5 mm and the average particle size of grain distribution of 7.5 μm is obtained. No annealing is required.

The rapid solidification flake is placed in a nitrogen atmosphere of 0.1-2.0 MPa for the gas-solid-phase reaction, with the reaction temperature of 400° C. and the reaction duration of 1 hour.

The material that has been treated via the above steps is pulverized by using a ball mill, with the pulverizing duration of 5 hours and the required energy of 60 kJ.

### Example 2

The other raw-material components than nitrogen are mixed, which include the rare-earth element Sm, and Fe, Co and Nb, wherein the atom percentages of the mixture are Sm 8.5%, Fe 76%, Co 8% and Nb 5%.

By using the above raw materials, based on the strip-casting technique, the samarium-iron master alloy is prepared. The rotation speed of the roller is 50 meters per second, the duration of cooling to normal temperature is 8 hours, and a flake with the thickness of 0.5 mm and the average particle size of grain distribution of 7.3 μm is obtained. No annealing is required.

The rapid solidification flake is placed in a nitrogen atmosphere of 0.1-2.0 MPa for the gas-solid-phase reaction, with the reaction temperature of 400° C. and the reaction duration of 150 hours.

The material that has been treated via the above steps is pulverized by using a ball mill, with the pulverizing duration of 5 hours and the required energy of 60 kJ.

### Example 3

The other raw-material components than nitrogen are mixed, which include the rare-earth element Sm, and Fe, Co and Nb, wherein the atom percentages of the mixture are Sm 8.5%, Fe 76%, Co 8% and Nb 5%.

By using the above raw materials, based on the strip-casting technique, the samarium-iron master alloy is prepared. The rotation speed of the roller is 80 meters per second, the duration of cooling to normal temperature is 10 hours, and a flake with the thickness of 0.4 mm and the average particle size of grain distribution of 6.9 μm is obtained. No annealing is required.

The rapid solidification flake is placed in a nitrogen atmosphere of 0.1-2.0 MPa for the gas-solid-phase reaction, with the reaction temperature of 400° C. and the reaction duration of 200 hours.

The material that has been treated via the above steps is pulverized by using a ball mill, with the pulverizing duration of 5 hours and the required energy of 60 kJ.

### Example 4

The other raw-material components than nitrogen are mixed, which include the rare-earth element Sm, and Fe, Co and Nb, wherein the atom percentages of the mixture are Sm 8.5%, Fe 76%, Co 8% and Nb 5%.

By using the above raw materials, based on the strip-casting technique, the samarium-iron master alloy is prepared. The rotation speed of the roller is 50 meters per second, the duration of cooling to normal temperature is 10 hours, and a flake with the thickness of 0.4 mm and the average particle size of grain distribution of 7.3 μm is obtained. No annealing is required.

The rapid solidification flake is placed in a nitrogen atmosphere of 0.1-2.0 MPa for the gas-solid-phase reaction, with the reaction temperature of 600° C. and the reaction duration of 150 hours.

The material that has been treated via the above steps is pulverized by using a ball mill, with the pulverizing duration of 5 hours and the required energy of 60 kJ.

### Example 5

The other raw-material components than nitrogen are mixed, which include the rare-earth element Sm, and Fe, Co and Nb, wherein the atom percentages of the mixture are Sm 8.5%, Fe 76%, Co 8% and Nb 5%.

By using the above raw materials, based on the strip-casting technique, the samarium-iron master alloy is prepared. The rotation speed of the roller is 50 meters per second, the duration of cooling to normal temperature is 8 hours, and a flake with the thickness of 0.4 mm and the average particle size of grain distribution of 7.3 μm is obtained. No annealing is required.

The rapid solidification flake is placed in a nitrogen atmosphere of 0.1-2.0 MPa for the gas-solid-phase reaction, with the reaction temperature of 800° C. and the reaction duration of 150 hours.

The material that has been treated via the above steps is pulverized by using a ball mill, with the pulverizing duration of 6 hours and the required energy of 65 kJ.

### Example 6

The other raw-material components than nitrogen are mixed, which include the rare-earth element Sm, and Fe, Co and Nb, wherein the atom percentages of the mixture are Sm 8.5%, Fe 76%, Co 8% and Nb 5%.

By using the above raw materials, based on the strip-casting technique, the samarium-iron master alloy is prepared. The rotation speed of the roller is 50 meters per second, the duration of cooling to 40° C. is 8 hours, and a flake with the thickness of 0.4 mm and the average particle size of grain distribution of 7.3p m is obtained. No annealing is required.

The rapid solidification flake is placed in a nitrogen atmosphere of 0.1-2.0 MPa for the gas-solid-phase reaction, with the reaction temperature of 600° C. and the reaction duration of 60 hours.

The material that has been treated via the above steps is pulverized by using a ball mill, with the pulverizing duration of 6 hours and the required energy of 70 kJ.

### Example 7

The other raw-material components than nitrogen are mixed, which include the rare-earth element Sm, and Fe, Ti and Cr, wherein the atom percentages of the mixture are Sm 6%, Fe 72.8%, Ti 3% and Cr 3%.

By using the above raw materials, based on the strip-casting technique, the samarium-iron master alloy is prepared. The rotation speed of the roller is 50 meters per second, the duration of cooling to 40° C. is 8 hours, and a flake with the thickness of 0.4 mm and the average particle size of grain distribution of 7.3p m is obtained. No annealing is required.

The rapid solidification flake is placed in a nitrogen atmosphere of 0.1-2.0 MPa for the gas-solid-phase reaction, with the reaction temperature of 600° C. and the reaction duration of 60 hours.

The material that has been treated via the above steps is pulverized by using a ball mill, with the pulverizing duration of 4 hours and the required energy of 80 kJ.

### Example 8

The other raw-material components than nitrogen are mixed, which include the rare-earth element Sm, and Fe, V and Mn, wherein the atom percentages of the mixture are Sm 6%, Fe 72.8%, V 3% and Mn 3%.

By using the above raw materials, based on the strip-casting technique, the samarium-iron master alloy is prepared. The rotation speed of the roller is 50 meters per second, the duration of cooling to normal temperature is 10 hours, and a flake with the thickness of 0.5 mm and the average particle size of grain distribution of 7.5 μm is obtained. No annealing is required.

The rapid solidification flake is placed in a nitrogen atmosphere of 0.1-2.0 MPa for the gas-solid-phase reaction, with the reaction temperature of 400° C. and the reaction duration of 1 hour.

The material that has been treated via the above steps is pulverized by using a ball mill, with the pulverizing duration of 5 hours and the required energy of 60 kJ.

### Example 9

The other raw-material components than nitrogen are mixed, which include the rare-earth element Sm, and Fe, wherein the atom percentages of the mixture are Sm 9.5% and Fe 89.5%.

By using the above raw materials, based on the strip-casting technique, the samarium-iron master alloy is prepared. The rotation speed of the roller is 50 meters per second, the duration of cooling to normal temperature is 8 hours, and a flake with the thickness of 0.5 mm and the average particle size of grain distribution of 7.3 μm is obtained. No annealing is required.

The rapid solidification flake is placed in a nitrogen atmosphere of 0.1-2.0 MPa for the gas-solid-phase reaction, with the reaction temperature of 400° C. and the reaction duration of 150 hours.

The material that has been treated via the above steps is pulverized by using a ball mill, with the pulverizing duration of 5 hours and the required energy of 60 kJ.

### Example 10

The other raw-material components than nitrogen are mixed, which include the rare-earth element Sm, and Fe, Ni and Mo, wherein the atom percentages of the mixture are Sm 8.5%, Fe 76%, Ni 8% and Mo 5%.

By using the above raw materials, based on the strip-casting technique, the samarium-iron master alloy is prepared. The rotation speed of the roller is 80 meters per second, the duration of cooling to normal temperature is 10 hours, and a flake with the thickness of 0.4 mm and the average particle size of grain distribution of 6.9 μm is obtained. No annealing is required.

The rapid solidification flake is placed in a nitrogen atmosphere of 0.1-2.0 MPa for the gas-solid-phase reaction, with the reaction temperature of 400° C. and the reaction duration of 200 hours.

The material that has been treated via the above steps is pulverized by using a ball mill, with the pulverizing duration of 5 hours and the required energy of 60 kJ.

### Example 11

The other raw-material components than nitrogen are mixed, which include the rare-earth element Sm, and Fe, Cu and Zn, wherein the atom percentages of the mixture are Sm 8.5%, Fe 76%, Cu 8% and Zn 5%.

By using the above raw materials, based on the strip-casting technique, the samarium-iron master alloy is prepared. The rotation speed of the roller is 50 meters per second, the duration of cooling to normal temperature is 8 hours, and a flake with the thickness of 0.4 mm and the average particle size of grain distribution of 7.3 μm is obtained. No annealing is required.

The rapid solidification flake is placed in a nitrogen atmosphere of 0.1-2.0 MPa for the gas-solid-phase reaction, with the reaction temperature of 800° C. and the reaction duration of 150 hours.

The material that has been treated via the above steps is pulverized by using a ball mill, with the pulverizing duration of 6 hours and the required energy of 65 kJ.

### Example 12

The other raw-material components than nitrogen are mixed, which include the rare-earth element Sm, and Fe and Zr, wherein the atom percentages of the mixture are Sm 8.5%, Fe 76% and Zr 13%.

By using the above raw materials, based on the strip-casting technique, the samarium-iron master alloy is prepared. The rotation speed of the roller is 50 meters per second, the duration of cooling to 40° C. is 8 hours, and a flake with the thickness of 0.4 mm and the average particle size of grain distribution of 7.3p m is obtained. No annealing is required.

The rapid solidification flake is placed in a nitrogen atmosphere of 0.1-2.0 MPa for the gas-solid-phase reaction, with the reaction temperature of 600° C. and the reaction duration of 60 hours.

The material that has been treated via the above steps is pulverized by using a ball mill, with the pulverizing duration of 6 hours and the required energy of 70 kJ.

The rare-earth permanent magnetic powder according to the embodiments of the present disclosure, as compared with conventional rare-earth permanent magnetic powders, can have better comprehensive properties. While the magnetic properties have been improved, the density of the magnetic powder can be increased, and the particle-size distribution of the magnetic powder can be more uniform. Some of the advantages of the embodiments of the present disclosure over the prior art will be described below with reference to the particular experimental data.

TABLE 1
properties of the magnetic powder

| | Property parameter | | | | | | | |
|---|---|---|---|---|---|---|---|---|
| | | | | | | | Thermogravimetric | |
| | | | | | | | analysis | |
| | Maximum | | Intrinsic | | | | (@400° C., and | |
| | Energy | | coercive | Particle | Particle | Particle | air atmosphere) | Compression |
| | Product | Remanence | force | size x10 | size x50 | size x99 | weight increase | density |
| unit | MGOe | kGs | kOe | μm | μm | μm | % | g/cm³ |
| Example 1 | 36.299 | 14.589 | 10.943 | 0.76 | 2.05 | 6.88 | 3.2 | 5.5 |
| Example 2 | 37.685 | 14.489 | 11.265 | 0.69 | 2.03 | 6.45 | 3.2 | 5.1 |
| Example 3 | 37.399 | 14.289 | 12.088 | 0.60 | 2.00 | 5.93 | 3.1 | 5.2 |
| Example 4 | 38.533 | 14.462 | 11.668 | 0.73 | 2.13 | 6.77 | 2.9 | 6.2 |
| Example 5 | 39.198 | 14.662 | 11.738 | 0.69 | 2.22 | 7.06 | 2.8 | 6.5 |
| Example 6 | 40.336 | 14.783 | 12.138 | 0.65 | 2.28 | 8.10 | 2.7 | 7.2 |
| Example 7 | 37.884 | 14.755 | 10.255 | 0.92 | 2.55 | 9.35 | 2.5 | 8.5 |

It can be seen that the rare-earth permanent magnetic powder according to the embodiments of the present disclosure does not only obtain better magnetic properties such as the maximum energy product, the remanence and the intrinsic coercive force, but also obtains more uniform particle-size distribution and compression density. Moreover, in the thermogravimetric analysis, in the environment of 400° C. and an air atmosphere, the weight increase is less than 3.2%, which indicates that the rare-earth permanent magnetic powder can still maintain a good stability in a high-temperature environment. Therefore, the rare-earth permanent magnetic powder can have good comprehensive properties. The present disclosure, while improving the comprehensive properties (the maximum energy product) of the magnetic powder and ensuring a wide granularity distribution, increases the compression density and the coercive force, and reduces the loss after the formation of the magnetic powder.

The preparation of the high-density low-loss rare-earth bonded magnet. Example 13

The high-density rare-earth permanent magnetic powder prepared in Example 6, polyamide resin (Nylon 12), a titanate coupling agent, diethylhexyl phthalate (DOP), silicon dioxide and butyl hydroxy anisd (BHA) are mixed, to obtain a mixture. The ratio of the polyamide resin (Nylon 12), the titanate coupling agent, the diethylhexyl phthalate (DOP), the silicon dioxide and the butyl hydroxy anisd is 90:2:2:4:2, and the masses and the proportions in the mixture of the polyamide resin (Nylon 12), the titanate, the diethylhexyl phthalate (DOP), the silicon dioxide and the butyl hydroxy anisd are shown in Table 2.

The hybrided pellet is heated at 200° C. to melt, subsequently added into an injection molding machine where the magnetic orientation field is 8 kOe, and injection-molded, to obtain the high-density low-loss rare-earth bonded magnet.

Subsequently, an irreversible-loss test (GB/T 40794-2021) is performed to the high-density low-loss rare-earth bonded magnet, wherein the condition of the irreversible-loss test is a constant temperature of 120° C. for 192 h.

TABLE 2
the properties of the high-density
low-loss rare-earth bonded magnet

| | Proportion of | Maximum | | Intrinsic | | Irre- |
|---|---|---|---|---|---|---|
| | binder and | Energy | Rema- | coercive | Den- | versible |
| | processing | Product | nence | force | sity | flux |
| Serial | aid | (BH)max | Br | Hcj | (g/ | loss |
| number | (%) | (MGOe) | (KGs) | (KOe) | cm³) | (%) |
| Sample 1 | 5 | 14.4 | 7.5 | 10.2 | 5.35 | 3.5 |
| Sample 2 | 5.3 | 14.1 | 7.3 | 10.3 | 5.27 | 3.4 |
| Sample 3 | 7.2 | 13.5 | 7.2 | 10.5 | 5.13 | 3.1 |
| Sample 4 | 9.3 | 12.8 | 7.0 | 10.8 | 5.02 | 3.0 |

### Example 14

The high-density rare-earth permanent magnetic powder prepared in Example 7, polyamide resin (Nylon 12), a titanate coupling agent, diethylhexyl phthalate (DOP), silicon dioxide and butyl hydroxy anisd (BHA) are mixed, to obtain a mixture. The ratio of the polyamide resin (Nylon 12), the titanate coupling agent, the diethylhexyl phthalate (DOP), the silicon dioxide and the butyl hydroxy anisd is 90:2:2:4:2, and the masses and the proportions in the mixture of the polyamide resin (Nylon 12), the titanate coupling agent, the diethylhexyl phthalate (DOP), the silicon dioxide and the butyl hydroxy anisd are shown in Table 3.

The hybrided pellet is heated at 200° C. to melt, subsequently added into an injection molding machine where the magnetic orientation field is 8 kOe, and injection-molded, to obtain the high-density low-loss rare-earth bonded magnet.

Subsequently, an irreversible-loss test (GB/T 40794-2021) is performed to the high-density low-loss rare-earth bonded magnet, wherein the condition of the irreversible-loss test is a constant temperature of 120° C. for 192 h. PGP-23 T2

TABLE 3
the properties of the high-density
low-loss rare-earth bonded magnet

| | Proportion of | Maximum | | Intrinsic | | Irre- |
|---|---|---|---|---|---|---|
| | binder and | Energy | Rema- | coercive | Den- | versible |
| | processing | Product | nence | force | sity | flux |
| Serial | aid | (BH)max | Br | Hcj | (g/ | loss |
| number | (%) | (MGOe) | (KGs) | (KOe) | cm³) | (%) |
| Sample 5 | 5 | 14.8 | 7.8 | 9.5 | 5.56 | 3.3 |
| Sample 6 | 5.3 | 14.6 | 7.6 | 9.5 | 5.50 | 3.1 |
| Sample 7 | 7.2 | 14.2 | 7.4 | 9.6 | 5.33 | 3.0 |
| Sample 8 | 9.3 | 13.2 | 7.2 | 9.7 | 5.17 | 2.8 |

### Example 15

The high-density rare-earth permanent magnetic powder prepared in Example 6, a thermoplastic elastomer (TPE), oleic acid, butyl hydroxy anisd (BHA) and magnesium hydroxide are mixed, to obtain a mixture. The ratio of the thermoplastic elastomer (TPE), the oleic acid, the butyl hydroxy anisd (BHA) and the magnesium hydroxide is 88:6:4:2, and the masses and the proportions in the mixture of the thermoplastic elastomer (TPE), the oleic acid, the butyl hydroxy anisd (BHA) and the magnesium hydroxide are shown in Table 4.

The hybrided pellet is heated at 180° C. to melt, subsequently added into an injection molding machine where the magnetic orientation field is 8 kOe, and injection-molded, to obtain the high-density low-loss rare-earth bonded magnet.

Subsequently, a flame-retardance test and a hardness test are performed to the high-density low-loss rare-earth bonded magnet.

TABLE 4
the properties of the high-density low-loss rare-earth bonded magnet

| | | | Maximum | | | | |
|---|---|---|---|---|---|---|---|
| | Proportion of | Proportion | Energy | | Intrinsic | | |
| | binder and | of flame | Product | Remanence | coercive | Flame | |
| Serial | processing aid | retardant | (BH)max | Br | force Hcj | retardance | Shore A |
| number | (%) | (%) | (MGOe) | (KGs) | (KOe) | Level | Hardness |
| Sample 9 | 12.6 | 4 | 7.8 | 5.9 | 9.3 | V0 | 65A |
| Sample 10 | 23.5 | 4 | 7.6 | 5.4 | 9.3 | V0 | 60A |
| Sample 11 | 24.4 | 4 | 7.3 | 5.3 | 9.2 | V0 | 55A |
| Sample 12 | 25.8 | 4 | 7.0 | 5.1 | 9.4 | V0 | 50A |

### Example 16

The high-density rare-earth permanent magnetic powder prepared in Example 6, nitrile rubber, a titanate coupling agent, benzenopoly acid ester and oleic acid are mixed, to obtain a mixture. The ratio of the nitrile rubber, the titanate coupling agent, the benzenopoly acid ester and the oleic acid is 88:2:4:6, and the masses and the proportions in the mixture of the nitrile rubber, the titanate coupling agent, the benzenopoly acid ester and the oleic acid are shown in Table 5.

The mixture is treated by using a double-screw extruder into a hybrided pellet.

The hybrided pellet is heated at 80° C. to melt, subsequently added into an injection molding machine where the magnetic orientation field is 8 kOe, and injection-molded, to obtain the high-density low-loss rare-earth bonded magnet.

Subsequently, an irreversible-loss test (GB/T 40794-2021) is performed to the high-density low-loss rare-earth bonded magnet, wherein the condition of the irreversible-loss test is a constant temperature of 120° C. for 192 h.

TABLE 5
the properties of the high-density
low-loss rare-earth bonded magnet

| | Proportion of | Maximum | | Intrinsic | | Irre- |
|---|---|---|---|---|---|---|
| | binder and | Energy | Rema- | coercive | Den- | versible |
| | processing | Product | nence | force | sity | flux |
| Serial | aid | (BH)max | Br | Hcj | (g/ | loss |
| number | (%) | (MGOe) | (KGs) | (KOe) | cm³) | (%) |
| Sample 13 | 4 | 14.3 | 7.8 | 10.6 | 5.12 | 3.5 |
| Sample 14 | 4.5 | 14.1 | 7.5 | 10.5 | 5.08 | 3.4 |
| Sample 15 | 6.8 | 13.9 | 7.2 | 10.9 | 4.99 | 3.1 |
| Sample 16 | 8.9 | 13.5 | 7.1 | 10.7 | 4.87 | 2.9 |

### Example 17

The high-density rare-earth permanent magnetic powder prepared in Example 7, nitrile rubber, a titanate coupling agent, benzenopoly acid ester and oleic acid are mixed, to obtain a mixture. The ratio of the nitrile rubber, the titanate coupling agent, the benzenopoly acid ester and the oleic acid is 88:2:4:6, and the masses and the proportions in the mixture of the nitrile rubber, the titanate coupling agent, the benzenopoly acid ester and the oleic acid are shown in Table 6.

The mixture is treated by using a double-screw extruder into a hybrided pellet.

The hybrided pellet is heated at 80° C. to melt, subsequently added into an injection molding machine where the magnetic orientation field is 8 kOe, and injection-molded, to obtain the high-density low-loss rare-earth bonded magnet.

Subsequently, an irreversible-loss test (GB/T 40794-2021) is performed to the high-density low-loss rare-earth bonded magnet, wherein the condition of the irreversible-loss test is a constant temperature of 120° C. for 192 h.

TABLE 6
the properties of the high-density
low-loss rare-earth bonded magnet

| | Proportion of | Maximum | | Intrinsic | | Irre- |
|---|---|---|---|---|---|---|
| | binder and | Energy | Rema- | coercive | Den- | versible |
| | processing | Product | nence | force | sity | flux |
| Serial | aid | (BH)max | Br | Hcj | (g/ | loss |
| number | (%) | (MGOe) | (KGs) | (KOe) | cm³) | (%) |
| Sample 17 | 4 | 14.5 | 7.9 | 9.5 | 5.26 | 3.3 |
| Sample 18 | 4.5 | 14.4 | 7.7 | 9.5 | 5.19 | 3.1 |
| Sample 19 | 6.8 | 14.1 | 7.5 | 9.6 | 5.03 | 2.9 |
| Sample 20 | 8.9 | 13.9 | 7.3 | 9.6 | 4.98 | 2.8 |

### Example 18

The high-density rare-earth permanent magnetic powder prepared in Example 7, a thermoplastic elastomer (TPE50%+TPU50%), oleic acid, butyl hydroxy anisd (BHA) and magnesium hydroxide are mixed, to obtain a mixture. The ratio of the thermoplastic elastomer (TPE50%+TPU50%), the oleic acid, the butyl hydroxy anisd (BHA) and the magnesium hydroxide is 70:5:20:5, and the masses and the proportions in the mixture of the thermoplastic elastomer (TPE50%+TPU50%), the oleic acid, the butyl hydroxy anisd (BHA) and the magnesium hydroxide are shown in Table 7.

The mixture is treated by using a double-screw extruder into a hybrided pellet.

The hybrided pellet is heated at 150° C. to melt, subsequently added into an injection molding machine where the magnetic orientation field is 8 kOe, and injection-molded, to obtain the high-density low-loss rare-earth bonded magnet.

Subsequently, a flame-retardance test and a hardness test are performed to the high-density low-loss rare-earth bonded magnet.

TABLE 7
the properties of the high-density rare-earth permanent magnetic powder

| | | | Maximum | | | | |
|---|---|---|---|---|---|---|---|
| | Proportion of | Proportion | Energy | | Intrinsic | | |
| | binder and | of flame | Product | Remanence | coercive | Flame | |
| Serial | processing aid | retardant | (BH)max | Br | force Hcj | retardance | Shore A |
| number | (%) | (%) | (MGOe) | (KGs) | (KOe) | Level | Hardness |
| Sample 21 | 12.6 | 6 | 7.3 | 5.8 | 9.4 | V0 | 60A |
| Sample 22 | 23.5 | 6 | 7.3 | 5.6 | 9.3 | V0 | 55A |
| Sample 23 | 24.4 | 6 | 7.2 | 5.2 | 9.4 | V0 | 50A |
| Sample 24 | 25.8 | 6 | 7.0 | 5.0 | 9.5 | V0 | 50A |

It can be seen that, in the present disclosure, when the magnetic orientation field is reduced, the prepared high-density low-loss rare-earth bonded magnet can still have good comprehensive properties. Therefore, the present disclosure can, while effectively improving the comprehensive properties of the rare-earth bonded magnet, reduce the requirement on the magnetic orientation field in the preparation of the rare-earth bonded magnet, which can reduce the cost of the preparation of the rare-earth bonded magnet to a certain extent, to enable the rare-earth bonded magnet to be better applied in current commercial application environments.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

The description provided herein describes many concrete details. However, it can be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present disclosure may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail with reference to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A high-density rare-earth permanent magnetic powder, wherein a molecular formula of the high-density rare-earth permanent magnetic powder is SmₓFe_{100-x-y-z}M_{y}I_{z}, wherein 6.0≤x≤9.5, 0≤y≤13, and 1≤z≤15.2; and M is a 3d transition-group metal and/or 4d transition-group metal, and I is an interstitial atom, and comprises N, or a combination of N and H; and
the high-density rare-earth permanent magnetic powder has a maximum energy product not less than 36.299 MGOe, and a compression density not less than 5.5 g/cm³.

2. The high-density rare-earth permanent magnetic powder according to claim 1, wherein the 3d transition-group metal and/or 4d transition-group metal comprises one or more of Ti, V, Cr, Mn, Co, Ni, Cu, Zn, Zr, Nb and Mo.

3. The high-density rare-earth permanent magnetic powder according to claim 1, wherein a particle size of the high-density rare-earth permanent magnetic powder is 0.6 μm≤x10≤0.92 μm, 2 μm≤x50≤2.55 μm, and 5.93 μm≤x99≤8.1 μm.

4. The high-density rare-earth permanent magnetic powder according to claim 1, wherein the high-density rare-earth permanent magnetic powder has a remanence not less than 14.289 kGs, and an intrinsic coercive force not less than 10.255 kOe.

5. The high-density rare-earth permanent magnetic powder according to claim 1, wherein the high-density rare-earth permanent magnetic powder has a weight-increase percentage less than 3.2% in a thermogravimetric analysis at 400° C. in an air atmosphere.

6. A method for preparing the high-density rare-earth permanent magnetic powder according to claim 1, wherein the method comprises:
acquiring a raw material, wherein the raw material comprises an Sm element, an Fe element, and the 3d transition-group metal and/or 4d transition-group metal, and a ratio of the Sm element, the Fe element and the 3d transition-group metal and/or 4d transition-group metal in the raw material is equal to a ratio of the elements in the high-density rare-earth permanent magnetic powder;
preparing a samarium-iron master alloy by using the raw material;
performing a gas-solid-phase reaction of the samarium-iron master alloy in nitrogen or a mixed gas of nitrogen and hydrogen, to form a samarium-iron-nitrogen alloy SmₓFe_{100-x-y-z}M_{y}I_{z}; and
grinding the samarium-iron-nitrogen alloy, to obtain the high-density rare-earth permanent magnetic powder.

7. The method according to claim 6, wherein the step of preparing the samarium-iron master alloy by using the raw material comprises:
by using the raw material, based on a strip-casting technique, preparing the samarium-iron master alloy.

8. The method according to claim 7, wherein in the step of, by using the raw material, based on the strip-casting technique, preparing the samarium-iron master alloy, a rotation speed of a roller is 50-80 m/s, and a thickness of the prepared samarium-iron master alloy is less than 1 mm.

9. The method according to claim 6, wherein in the gas-solid-phase reaction, a reaction temperature is 400-800° C., a duration is 1-200 hours, and a gas pressure is 0.1-2.0 MPa.

10. The method according to claim 6, wherein in a process of the grinding, a total energy output is 60-80 KJ.

11. A high-density low-loss rare-earth bonded magnet, wherein the high-density low-loss rare-earth bonded magnet is prepared by using the high-density rare-earth permanent magnetic powder according to claim 1, a binder, and a processing aid.

12. The high-density low-loss rare-earth bonded magnet according to claim 11, wherein the binder comprises at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene, and/or comprises at least one of a copolymer, a blend and a polymer alloy that are formed based on at least one of chlorinated polyethylene, a polyamide resin, thermoplastic polyimide, a liquid-crystal polymer, polyphenylene sulfide, polyphenyl ether, polyolefin, modified polyolefin, polycarbonate, polymethyl methacrylate, polyether, polyether ketone, polyetherimide, polyformaldehyde and chlorosulfonated polyethylene.

13. The high-density low-loss rare-earth bonded magnet according to claim 11, wherein the binder comprises a thermoplastic elastomer.

14. The high-density low-loss rare-earth bonded magnet according to claim 11, wherein the processing aid comprises at least one of a coupling agent, a plasticizer, a lubricant and a flame retardant.

15. The high-density low-loss rare-earth bonded magnet according to claim 14, wherein the coupling agent comprises a titanate-type coupling agent and/or a silane-type coupling agent.

16. The high-density low-loss rare-earth bonded magnet according to claim 14, wherein the plasticizer comprises at least one of dioctyl phthalate DOP, a stearate salt, a fatty acid, a phosphate ester, a benzenopoly acid ester and an alkyl sulfonic acid ester.

17. The high-density low-loss rare-earth bonded magnet according to claim 14, wherein the lubricant comprises at least one of silicone oil, wax, a fatty acid, oleic acid, polyester, a synthesized ester, a carboxylic acid, aluminium oxide, silicon dioxide and titanium dioxide.

18. A method for preparing the high-density low-loss rare-earth bonded magnet according to claim 11, wherein the method comprises:
mixing the high-density rare-earth permanent magnetic powder, the binder and the processing aid, to obtain a mixture; and
treating the mixture by extrusion molding or injection molding in an environment where a magnetic orientation field is greater than 8 kOe, to generate the high-density low-loss rare-earth bonded magnet.

19. The method according to claim 18, wherein the step of treating the mixture by extrusion molding or injection molding in the environment where the magnetic orientation field is greater than 8 kOe, to generate the high-density low-loss rare-earth bonded magnet comprises:
if the extrusion molding is employed, milling the mixture in a mixing mill, to heat and melt the mixture, subsequently loading the mixture into a single-screw extruder where a magnetic orientation field is greater than 8 kOe, extruding by using the single-screw extruder, and subsequently cooling for formation, to obtain the high-density low-loss rare-earth bonded magnet.

20. The method according to claim 18, wherein the step of treating the mixture by extrusion molding or injection molding in the environment where the magnetic orientation field is greater than 8 kOe, to generate the high-density low-loss rare-earth bonded magnet comprises:
if the injection molding is employed, treating the mixture by using a double-screw extruder into a hybrided pellet; and
heating to melt the hybrided pellet, subsequently adding the hybrided pellet into an injection molding machine where a magnetic orientation field is greater than 8 kOe, and injection-molding, to obtain the high-density low-loss rare-earth bonded magnet.
